(19) United States
(12) Patent Application Publication
(10) Pub. No.: US 2008/0165290 A1
(43) Pub. Date: Jul. 10, 2008

(54) DIGTAL PHOTO FRAME WITH BACKGROUND COLOR EDITING FUNCTION

(75) Inventors: Xiao-Guang Li, Shenzhen City (CN); Kuan-Hong Hsieh, Shenzhen City (CN); Han-Che Wang, Shenzhen City (CN); Chun-Wei Pan, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/958,368

(22) Filed: Dec. 17, 2007

(30) Foreign Application Priority Data
Jan. 8, 2007 (CN) 200710200019.0

(51) Int. Cl. H04N 5/66

(52) U.S. Cl. 348/739

(57) ABSTRACT

A digital photo frame with a background color editing function includes a storage unit; an interface used for connecting with an external storage device; a display screen including a primary display area for displaying digital images and a secondary display area for displaying a default background color, wherein the secondary display area surrounds the primary display area; and a processing unit comprising: a digital image obtaining module for obtaining data of a digital image from the storage unit or the external storage device, and displaying the digital image on the primary display area; a hue obtaining module for obtaining the main hue of a digital image; and an editing module for changing the default background color into the main hue. Related methods are also provided.

### BACKGROUND

1. Technical Field

The present invention relates to a digital photo frame, and particularly to a digital photo frame which can edit background color.

2. General Background

A digital photo frame with a display screen has a memory capable of storing several photographs, and can quickly change the photographs to be displayed. A user can change the displayed photograph at his or her leisure.

However when a display size of the photograph is smaller than that of the display screen, the display screen has a blank area not displaying the digital image. The background color of the blank area is usually filled with a default background color, such as gray. In this way, color between area of the displayed digital image and the blank area will be inconsistent.

Accordingly, a heretofore need exists in the industry to overcome the aforementioned limitations.

### SUMMARY

A digital photo frame with a background color editing function includes a storage unit; an interface used for connecting with an external storage device; display screen including a primary display area for displaying digital images and a secondary display area for displaying a default background color, wherein the secondary display area surrounds the primary display area; and a processing unit comprising: a digital image obtaining module for obtaining data of a digital image from the storage unit or the external storage device, and displaying the digital image on the primary display area; a hue obtaining module for obtaining the main hue of a digital image; and editing module for changing the default background color into the main hue of the digital image.

A method of editing background color including: obtaining data of a digital image and displaying it on a primary display area; obtaining main hue of the digital image; changing a default background color of a secondary display area into the main hue; and displaying the background of the secondary display area according to the main hue.

Other advantages will be drawn from the following detailed description with reference to the attached drawings.

### BRIEF DESCRIPTION OF THE DRAWINGS

FIG. 1 is an exemplary block diagram of hardware infrastructure of a digital photo frame in accordance with a preferred embodiment of the invention.

FIG. 2 is an exemplary block diagram of a display screen in the digital photo frame of FIG. 1.

FIG. 3 is an exemplary block diagram of main function modules of a processing unit in the digital photo frame of FIG. 1.

FIG. 4 is a flowchart of a background color editing method implemented by the digital photo frame in accordance with a preferred embodiment of the invention.

FIG. 5 is an exemplary block diagram of hardware infrastructure of a digital photo frame in accordance with a second embodiment of the invention.

FIG. 6 is an exemplary block diagram of a display screen in the digital photo frame of FIG. 5.

FIG. 7 is an exemplary block diagram of main function modules of a processing unit in the digital photo frame of FIG. 5.

FIG. 8 is a second flowchart of a background color editing method implemented by the digital photo frame in accordance with the second embodiment of the invention.

### DETAILED DESCRIPTION OF THE EMBODIMENT

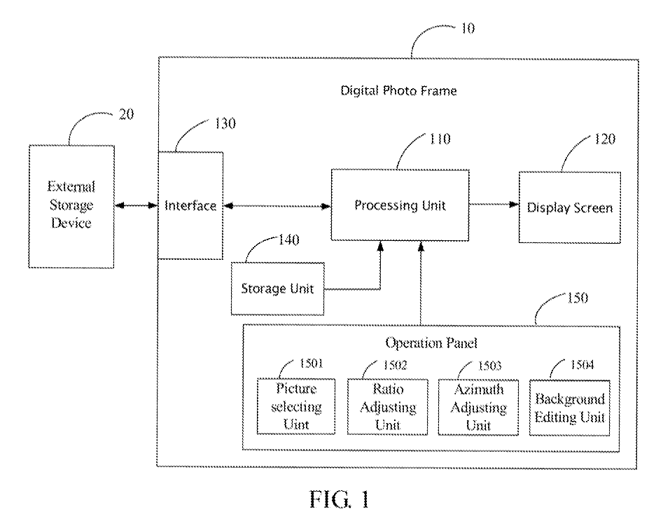

FIG. 1 is an exemplary block diagram of a hardware infrastructure of a digital photo frame in accordance with a preferred embodiment of the present invention. The digital photo frame 10 includes a processing unit 110, a display screen 120, an interface 130, a storage unit 140, and an operation panel 150.

The interface 130 is used for connecting with an external storage device 20, such as a memory card, a music player, a digital camera, and so on. The operation panel 150 includes a digital image selecting unit 1501, a ratio adjusting unit 1502, an azimuth adjusting unit 1503, and a background editing unit 1504. The digital image selecting unit 1501 is configured for sending a selection instruction to the processing unit 110. The processing unit 110 is configured for reading data of a digital image from the external storage device 20 or the storage unit 140 according to the selection instruction. The ratio adjusting unit 1502 and the azimuth adjusting unit 1503 are configured for sending a ratio adjusting instruction and an azimuth adjusting instruction to the processing unit 110 respectively. The processing unit 110 is configured for adjusting a display ratio and a display azimuth of a displayed digital image according to the ratio adjusting instruction and azimuth adjusting instruction. The background editing unit 1504 is configured for sending an editing instruction to the processing unit 110 and the processing unit 110 is configured for changing a default background color according to the editing instruction.

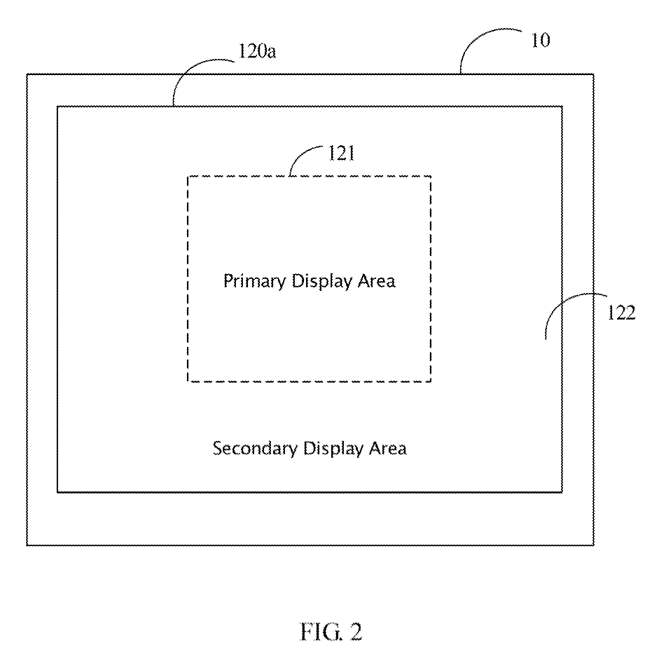

FIG. 2 is an exemplary block diagram of a display screen 120a of FIG. 1 in accordance with the preferred embodiment of the present invention. When a display area of the displayed digital image is smaller than that of the display screen 120a, the display screen 120a has a blank area. In this embodiment, as shown in FIG. 2, the blank area is defined as a secondary display area 122, and an area of the display screen 120a outputting the displayed digital image is defined as a primary display area 121. The secondary display area 122 locates around the primary display area 121. The primary display area 121 is configured for outputting the digital image, and the secondary display area 122 is configured for displaying the system background color.

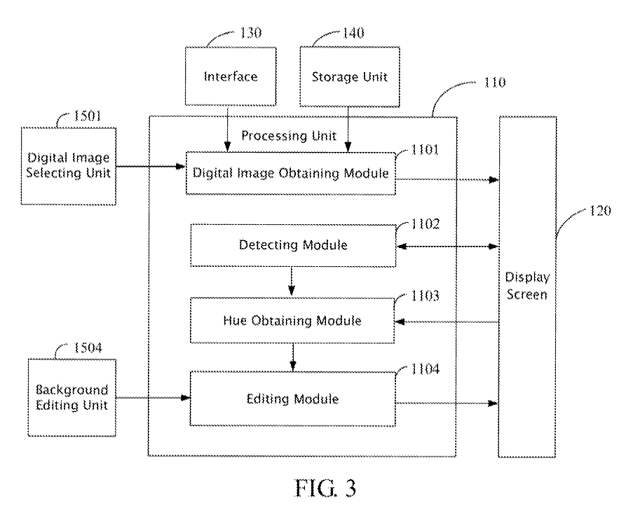

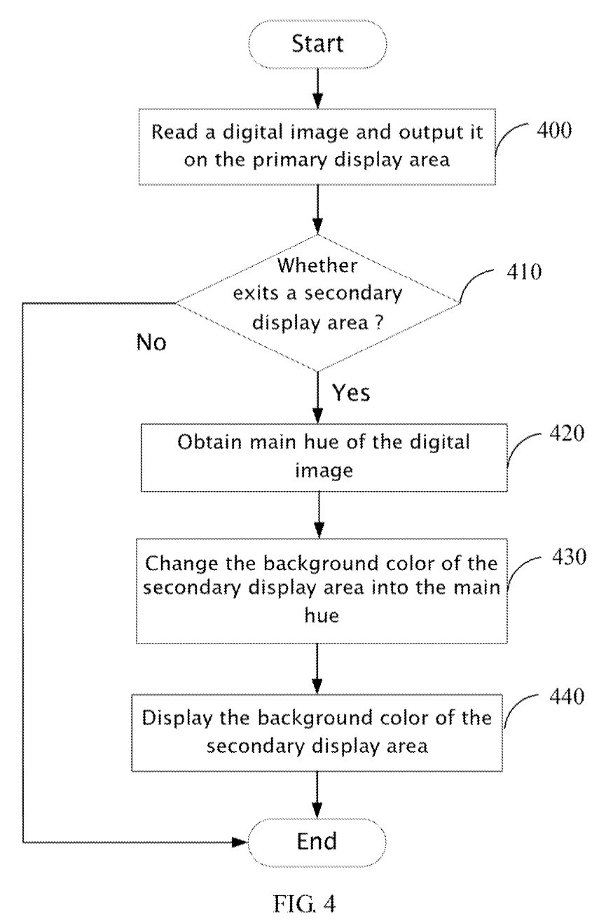

FIG. 3 is an exemplary block diagram of main function modules of the processing unit 110 of FIG. 1. The processing unit 110 includes a digital image obtaining module 1101, a detecting module 1102, a hue obtaining module 1103, and an editing module 1104. Description of the modules is given below together with the description of FIG. 4.

FIG. 4 is a flowchart of a background color editing method implemented by the digital photo frame 10 of FIG. 1 in accordance with the preferred embodiment of the present invention.

In step 400, the digital image obtaining module 1101 reads the digital image from the storage unit 140 or the external storage device 20 via the interface 130 according to the selection instruction from the digital image selecting unit 1501, and outputs the digital image via the display screen 120a.

In step 410, the detecting module 1102 detects and determines whether the primary display area is smaller than that of the display screen 120a. If the primary display area is equal to or larger than that of the display screen 120a, the process ends.

If the primary display area is smaller than that of the display screen 120a, in step 420, the hue obtaining module 1103 obtains a main hue of the displayed digital image. Typically, the hue obtaining module 1103 obtains color values (e.g. RGB values) of all pixels in the digital image and a color histogram of the digital image, statistically analyzes number of pixels in each color bin of the color histogram; the color bin that has most pixels is selected as the main hue of the digital image.

In step 430, the editing module 1104 receives the editing instruction from the background editing unit 1504 and changes the default background color into the main hue. The editing module 1104 can fill the secondary display area 122 with the main hue in a uniform color fill mode, a fountain fill mode, or other fill modes.

In step 440, the editing module 1104 displays the background color of the secondary display area 122 according to the main hue.

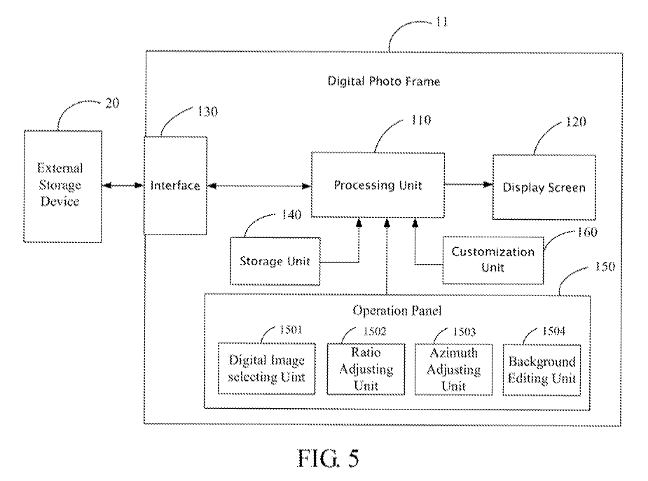

FIG. 5 is an alternative exemplary block diagram of a hardware infrastructure of another digital photo frame in accordance with a second embodiment of the invention. When compared with the digital photo frame 10 of FIG. 1, the digital photo frame 11 of FIG. 5 further includes a customization unit 160. The customization unit 160 can be a time/calendar unit for supplying time/calendar information, or other customization information.

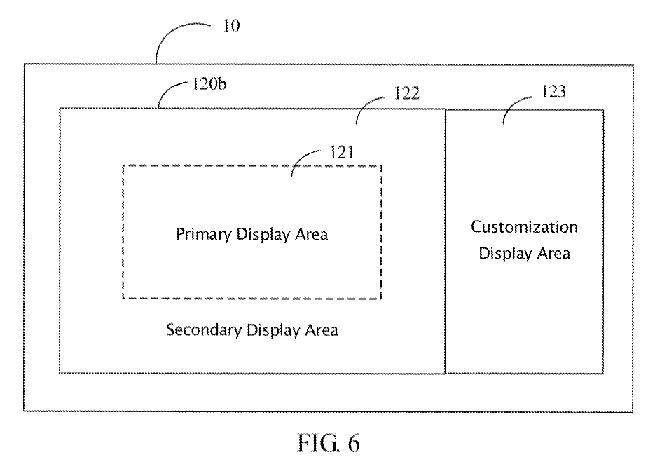

FIG. 6 is an exemplary block diagram of the display screen 120b of FIG. 5. In this embodiment, as shown in FIG. 5, the display screen 120b is physically divided into two areas 120b and 123. The area 120b is configured for outputting the digital image and has a similar display configuration as that of the display area 120a of FIG. 3. That is, when the display area of the digital image is smaller than the area 120b, the primary display area 121 is used for outputting the digital image, and the secondary display area 122 is used for displaying the system background. The area 123 is configured for displaying the customization information (e.g., time, calendar, and the like), and is defined as a customization display area 123.

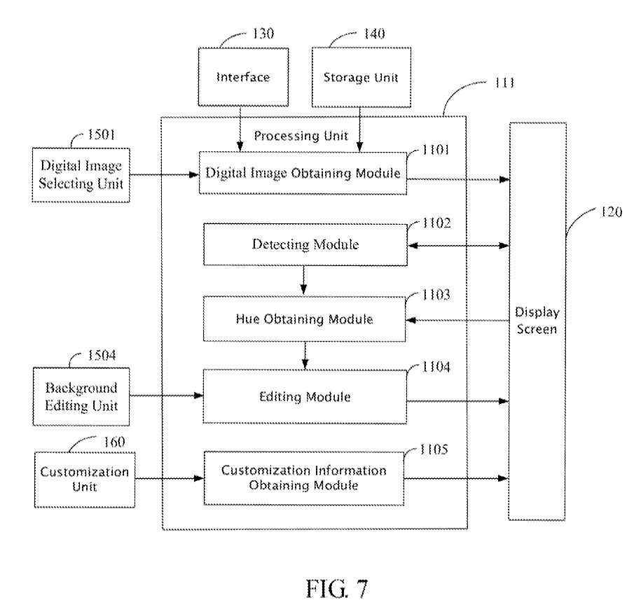

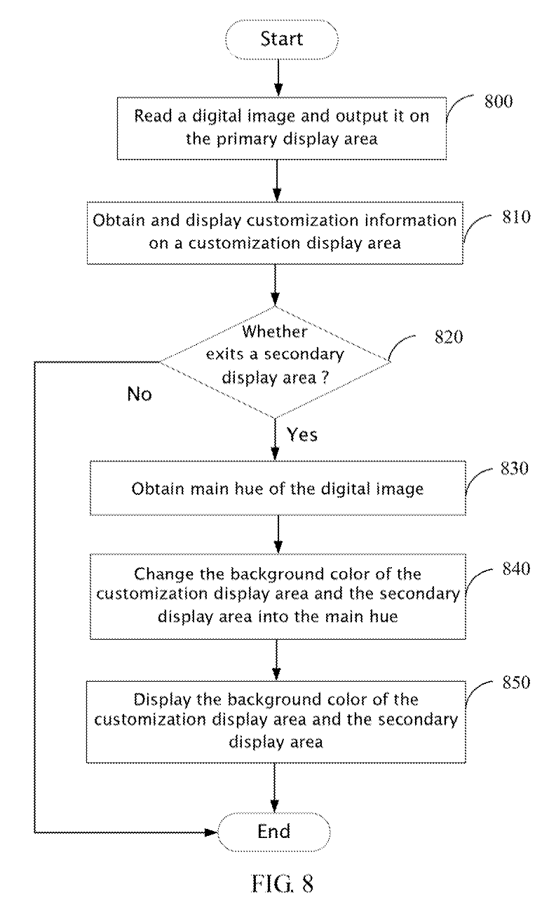

FIG. 7 is an exemplary block diagram of the main function modules of the processing unit 111 of FIG. 5. When compared with the processing unit 110 of FIG. 3, the processing unit 111 further includes a customization information obtaining module 1105 and the customization unit 160. Description of function of the modules of the processing unit 111 is given below together with the description of FIG. 8.

FIG. 8 is a second flowchart of a background color editing method implemented by the digital photo frame 11 in accordance with the second embodiment. When compared with FIG. 4, the flowchart in FIG. 8 further includes these steps: obtaining and displaying customization information on the customization display area 123 (in step 810); changing the background color of the customization display area 123 into the main hue (in step 840); and displaying the background of the customization display area 123 according to the main hue (in step 850).

Although the present invention has been specifically described on the basis of a preferred embodiment including preferred methods thereof, the invention is not to be construed as being limited thereto. Various changes or modifications may be made to the embodiment including the methods without departing from the scope and spirit of the invention.

What is claimed is:

1. A digital photo frame with a background color editing function, comprising:
a storage unit;
an interface used for connecting with an external storage device;
a display screen comprising a primary display area for displaying digital images and a secondary display area for displaying a default background color, wherein the secondary display area surrounds the primary display area; and
a processing unit comprising:
a digital image obtaining module for obtaining data of a digital image from the storage unit or the external storage device, and displaying the digital image on the primary display area;
a hue obtaining module for obtaining main hue of the digital image; and
an editing module for changing the default background color into the main hue of the digital image.

2. The digital photo frame according to claim 1, wherein the processing unit further comprises a detecting module for determining whether the display area shows a secondary display area.

3. The digital photo frame according to claim 1, further comprising a customization unit for supplying customization information, a customization information obtaining module for obtaining the customization information, and a customization information display area for displaying the customization information, wherein, the editing module changes a background color of the customization display area into the main hue.

4. The digital photo frame with background color editing function according to claim 3, wherein the customization unit is a time/calendar unit for supplying time/calendar information.

5. A method of editing background color comprising:
obtaining data of a digital image and displaying it on a primary display area;
obtaining main hue of the digital image;
changing a default background color of a secondary display area into the main hue; and
displaying the background of the secondary display area according to the main hue.

6. The method of editing background color according to claim 5, further comprising:
determining whether the display area shows a secondary display area.

7. The method of editing background color according to claim 5, further comprising:
obtaining customization information, displaying the customization information on a customization display area, changing a background color of the customization display area into the main hue.
